(19) United States
(12) Patent Application Publication
(10) Pub. No.: US 2017/0149073 A1
(43) Pub. Date: May 25, 2017

(54) CONTROLLED DISCHARGE OF AN ENERGY STORE USING REDOX SHUTTLE ADDITIVES

(71) Applicant: ZENTRUM FÜR SONNENENERGIE-UND WASSERSTOFF- FORSCHUNG BADEN-WÜRTTEMBERG GEMEINNÜTZIGE STIFTUNG, Stuttgart (DE)

(72) Inventors: Harry DOERING, Elchingen (DE); Mario WACHTLER, Ulm (DE); Margret WOHLFAHRT-MEHRENS, Illertissen-Tiefenbach (DE); Brita EMMERMACHER, Ulm (DE)

(21) Appl. No.: 15/321,336

(22) PCT Filed: Jun. 19, 2015
(86) PCT No.: PCT/EP2015/063793

§ 371 Date: Dec. 22, 2016

(30) Foreign Application Priority Data
Jun. 27, 2014 (DE) 10 2014 109 045.4

(51) Int. Cl. H01M 8/04791; H01M 8/20; H01M 8/04082; H01M 8/18

(52) U.S. Cl. CPC H01M 8/0482; H01M 8/188; H01M 8/20; H01M 8/04201; H01M 2250/20

(57) ABSTRACT

The invention relates to an arrangement and a method for the controlled discharge of an energy store using redox shuttle additives and to the use of redox shuttle additives for the controlled discharge of an energy store. The energy store arrangement comprises a storage container with a redox shuttle additive which is dispensed into the electrolytes of the energy store upon triggering a dispensing device such that the energy store is partly or completely discharged, wherein the redox shuttle additive is oxidized on the cathode and reduced on the anode. The redox shuttle additive has a redox potential which is less than or equal to the potential of the partially or completely discharged cathode and greater than or equal to the potential of the partially or completely discharged anode.

The invention relates to an arrangement and a method for the controlled discharge of an energy store using redox shuttle additives, and to the use of redox shuttle additives for the controlled discharge of an energy store.

### BACKGROUND OF THE PRIOR ART

Danger of accident-damaged energy store systems

In hybrid vehicles, plug-in hybrid vehicles, and electric vehicles, electrochemical energy store systems are usually used as components for energy storage. A common feature of the specified vehicle types is that large amounts of electrical energy have to be provided and transferred. The increasing electrification of vehicles and the growing number of electric hybrid vehicles and purely electric vehicles means that energy store systems of high voltage and high energy contents are being used to an increasing extent. On account of the high energy contents and high battery voltages, these energy store systems constitute a potential safety risk when in the charged state. In particular in the case of accident-damaged vehicles, the question must be asked as to how the energy store system can be made safe for humans and the environment.

In unsafe situations, for example after the tripping of protective mechanisms (wiring inside or outside the cell, disconnection of the main contactors, tripping of the fuse, etc.) or after the interruption of the current path (for example after collisions), it may be that the energy store system, such as the battery, can no longer safely discharge electrically. Recovery of the charged or partially charged battery is associated with high risk on account of the high voltage level or the high energy contents. Access to the individual cells is often impossible, difficult, very complex, or associated with additional risks, and therefore a step-by-step dismantling of the battery and recovery of the individual components is not readily possible.

Similar problems can result in the event of damage or failure also for large energy store systems in other fields of application, for example stationary energy storage.

In hybrid, plug-in hybrid, and electric vehicles, electrochemical energy store systems are usually used as components for energy storage. These electrochemical energy store systems are usually based on nickel-metal hybrid (NiMH) or lithium-ion (Li-ion) technology, wherein other technologies are also used as energy suppliers and stores, such as double-layer capacitors, lead-acid or nickel-zinc batteries, or also air-breathing batteries, which use a zinc/air or lithium air interaction.

The safety of the energy store is one of the key points here with regard to the development of energy store systems, such as Li-ion batteries. A distinction is made here between safety at cell and system level. Fire safety at cell level is significantly influenced by the choice of the electrolytes.

In accordance with the prior art, electrolytes which consist of at least one lithium salt dissolved in a mixture of organic solvents, usually linear and cyclic organic carbonates or also esters, are used in Li-ion batteries. All solvents currently used are flammable and combustible and therefore constitute a high fire load.

The safety at system level is usually ensured by energy control circuits including energy cell monitoring with operation as intended. Such an energy control circuit determines the state of charge of the energy store and controls, inter alia, main contactors for switching the energy store on and off. The energy control circuit also controls the energy flow, i.e. the amount of energy that is to be removed from or fed to the store.

Due to improper use of the energy store or due to an accident, the energy store and/or the energy store circuit can be damaged when the energy store is arranged in a vehicle. For example, any switching of the main contactors can thus no longer be possible, and as a result the contactors pass into their rest position, i.e. the main contactors are opened. However, in most cases the entire voltage continues to be applied at the cells of the energy store.

A disadvantage in this case is that the energy store can no longer be selectively discharged from outside. Due to the voltage applied at the energy store, a potential can then reach a damaged housing, for example, which hinders recovery of the accident-damaged battery and places recovery workers at risk.

It is also possible that electric short circuits will ignite the combustible electrolyte of the energy store or, in the case of an accident-damaged vehicle, any leaked fuel.

Document WO2011144300, in order to solve the aforementioned problems, provides an energy store arrangement comprising an energy store that has electric poles, via which the energy store at the least can be discharged, and that has an electrically conductive conveyed agent in the form of a fluid or fine-grain bulk material, or a mixture of the two, wherein the conveyed agent is delivered from a storage container into a collection container, in such a way that the electric poles of the energy store are directly or indirectly electrically conductively connected to one another via the conveyed agent in the collection container.

Redox Shuttle Additives

Redox shuttle additives have been described previously in the literature for use as reversible protection against overcharge of an energy store. Overcharge can occur when, once the end charging voltage has been reached, a charging current is applied and therefore the admissible charging voltage is exceeded. Overcharge can lead to chemical and electrochemical reaction and therefore to degradation of the battery components. The resultant rise in temperature in turn leads to an acceleration of the reactions, which can cause the battery to explode.

In order to prevent an overcharge, the addition of chemical components which are usually referred to as redox shuttle additives has been proposed. Compounds of this type are oxidised when a certain charging potential is exceeded. The oxidised form is stable and can move towards the anode by migration or diffusion, and can be discharged (reduced) there to the starting form. The reduced species can then, again, be oxidised at the cathode, and so on.

A prerequisite for the use of a substance as protection against overcharge is therefore that it can be reversibly oxidised and reduced and is sufficiently stable both in the reduced and oxidised state, and also that it has a suitable redox potential, which is higher than the end charging potential of the cathode. A further prerequisite is a sufficient solubility and movability in the electrolyte so as to transport the applied current fully between cathode and anode in the event of overcharge.

In spite of intensive research, only few substances have previously been known which satisfy all of these requirements. Examples include 2,5-di-tert-butyl-1,4-dimethoxybenzene [J. Chen, C, Buhrmester, J R Dahn; Electrochemical and Solid-State Letters 8 (2005), A59-A62] and 10-methylphenothiazine [C. Buhrmester, L. Moshurchak, R L C Wang, J R Rahn; Journal of The Electrochemical Society 153 (2006), A288-A294]. The found redox potentials are often too low for applications in combination with the cathode materials currently used. The cathode material LiFePO₄ is thus usually charged up to potentials of approximately 4.0 V vs. Li/Li⁺, and LiCoO₂ and Li(Ni_{0.33}Mn_{0.33}Co_{0.33})O₂ are usually charged up to potentials of approximately 4.2 to 4.3 vs. Li/Li⁺. Redox shuttle additives for protection against overcharge must be active at these, or higher potentials accordingly.

### Technical Problem and Summary of the Invention

In the present invention it has surprisingly been found that, in addition to the above-mentioned redox shuttle additives, many substances that have a redox potential too low for use as protection against overcharge are outstandingly suitable for the discharge of energy store systems in a controlled manner.

The object of the present invention is therefore to discharge an energy store in a controlled manner, in particular for the case in which the energy store and/or an associated energy control circuit connected thereto has been damaged as a result of a defect or accident.

The object is achieved by providing an energy store arrangement according to claim 1 and by a method according to claim 14. Embodiments and developments of the concept of the invention are disclosed in the dependent claims.

The object is achieved in particular by an energy store arrangement containing

(1) an energy store having at least one anode, at least one cathode, electrolyte, and electric poles, via which the energy store at the least can be discharged,

(2) a storage container, containing a redox shuttle additive, and

(3) a triggerable delivery device by means of which, when triggered, the redox shuttle additive is delivered into the electrolyte of the energy store in such a way that the cathode and the anode of the energy store are in contact with the redox shuttle additive provided in the electrolyte and the energy store is discharged partially or fully in that the redox shuttle additive is oxdised at the cathode and reduced at the anode,

wherein the redox shuttle additive has a redox potential which is less than or equal to the potential of the partially or fully discharged cathode and is greater than or equal to the potential of the partially or fully discharged anode.

The problem is also achieved by a method for the controlled discharge of an energy store arrangement, as defined in any one of claims 1 to 13, said method comprising the steps of

i) triggering the delivery device, and

ii) delivering the redox shuttle additive from the storage container into the electrolyte of the energy store,

wherein the electrodes of the energy store come into contact with the redox shuttle additive present in the electrolyte and the energy store is partially or fully discharged in that the redox shuttle additive is oxidised at the cathode and is reduced at the anode, and

wherein the redox shuttle additive has a redox potential which is less than or equal to the potential of the partially or fully discharged cathode and greater than or equal to the potential of the partially or fully discharged anode.

The object is also achieved by the use of a redox shuttle additive for the controlled discharge of an at least partially charged energy store.

### DESCRIPTION OF THE DRAWINGS

FIG. 1: Profile of the cell voltage during the discharge of the cell following addition of different substances.

FIG. 2: Temperature profile during the discharge of the cells following addition of different substances.

### DETAILED DESCRIPTION OF THE INVENTION

Energy Store Arrangement

The energy store is typically a battery, preferably a rechargeable battery, for example a rechargeable lithium-ion secondary cell. The energy store can also be part of a stationary, portable or mobile application. It is typically a battery for a motor vehicle, such as a car battery, a battery for a hybrid vehicle, plug-in hybrid, or an electric vehicle.

The energy store arrangement is also at least partially charged, but can also be fully charged.

In a first embodiment the invention comprises an energy store arrangement containing.

(1) an energy store having at least one positive and at least one negative electrode, electrolyte, and electric poles, via which the energy store at the least can be discharged,

(2) a storage container, containing a redox shuttle additive, and

(3) a triggerable delivery device by means of which, when triggered, the redox shuttle additive is delivered into the electrolyte of the energy store in such a way that the electrodes of the energy store are in contact with the redox shuttle additive provided in the electrolyte and the energy store is discharged partially or fully in that the redox shuttle additive is oxidised at the positive electrode (“cathode”) and reduced at the negative electrode (“anode”),

wherein the redox shuttle additive has a redox potential which is less than or equal to the potential of the partially or fully discharged cathode and is greater than or equal to the potential of the partially or fully discharged anode.

A typical embodiment of an energy store arrangement for the controlled discharge of an energy store, said arrangement having at least one positive and at least one negative electrode, electrolyte, and electric poles, via which the energy store at the least can be discharged, a storage container, and also a triggerable delivery device, is described in WO 2011/144300, to which reference is hereby made.

In particular, the energy store and/or an energy control circuit controlling the energy store can be damaged by improper use of the energy store or by an accident when the energy store is arranged by way of example in a vehicle.

For example, a switching of a contactor in the energy control circuit can no longer be possible, and as a result the contactors pass into their rest position, i.e. the main contactors are opened. However, the entire voltage continues to be applied at the poles of the energy store. Due to the voltage applied at the energy store, a potential can now be applied to vehicle parts, which hinders recovery and places recovery workers at risk. There is also the possibility that electric short circuits will ignite the combustible electrolyte of the energy store or, in the case of an accident-damaged (hybrid) vehicle, any leaked fuel.

The solution approach according to the invention, for example similarly to the triggering of an airbag, now provides the delivery of a redox shuttle additive into the pole area of the cells and/or an area around the contactors of an energy control circuit via the triqgerable delivery device. The redox shuttle additive is preferably delivered from the storage container into the electrolyte of the energy store.

Since the redox shuttle additive can be oxidised at least partially reversibly and can be reduced at least partially reversibly, the redox shuttle additive can move towards the anode/cathode by migration or diffusion and can be converted there into the reduced/oxidised form. The reduced/oxidised species then in turn can be oxidised/reduced at the cathode/anode and thus converted into the oxidised/reduced form, and so on. The energy store poles are electrically connected by the presence of the redox shuttle additive in the electrolyte, whereby the energy store is discharged in a controlled manner. Here, the risk potential reduces continuously, or there is no longer any electrical risk posed by the energy store following full discharge.

Due to the discharge of the energy store, the inner chemical potential thereof is also reduced accordingly, such that, with direct contact of the electrodes within the energy store (separator break, penetration of the cells during recovery, etc.), there is also no longer any risk posed by the energy store. The energy store can be safely handled following full discharge thereof.

The redox shuttle additive is delivered in such a way that the electric poles of the energy store are electrically conductively connected to one another via the redox shuttle additive as described above. The release device can be triggered manually or directly or indirectly as a response to an event. The delivery device for this purpose can be embodied for example as a manually actuatable valve or as a valve that is, for example, electrically controlled.

For the case in which the energy store for example is part of a hybrid, plug-in hybrid, or electric vehicle, such an event can be damage to an energy control circuit of the energy store arrangement and/or the energy store, for example as a result of a vehicle accident. Such damage can be determined for example by appropriate sensors, and thus can indirectly prompt a triggering of the delivery device. In another embodiment the delivery device itself can have a device, such as its own crash sensor, optionally in conjunction with micro explosive charges, as in the case of an airbag for example, which directly triggers the delivery of the redox shuttle additive from the storage container. Alternatively, a predetermined breaking point can also be provided at the connection between the storage container and the electrolyte area connecting the electrodes, in which the redox shuttle additive is delivered.

The triggerable delivery device is preferably selected from a predetermined breaking point, micro explosive charge, a mechanically, thermally, chemically and/or electrically controlled release mechanism, preferably a valve and/or sensor, or a combination of various trigger mechanisms.

In an alternative embodiment of the energy store arrangement according to the invention, the redox shuttle additive is contained in a non-reactive form in the energy store, for example in the electrolyte of the energy store. Here, the redox shuttle additive is activated by being brought into contact with an activator component, which is usually contained in the storage container. Here, the activator component is delivered by means of the triggerable delivery device, when triggered, into the electrolyte of the energy store in such a way that the electrodes of the energy store are in contact with the activated redox shuttle additive, for example present in the electrolyte, and the energy store is partially or fully discharged in that the activated redox shuttle additive is oxidised at the cathode and reduced at the anode.

In a further embodiment the redox shuttle additive can also be added into the energy store arrangement by addition from outside, for example manual, mechanical, or electrical metered addition or by being poured in.

In an alternative embodiment the energy store arrangement can have active or passive cooling devices for improved cooling. For example in the case in which discharge is to occur very quickly within a few minutes, heat created during the controlled discharge can thus be dissipated, and a potential safety risk caused by the temperature increase can be avoided.

In an alternative embodiment, in particular with use of water-containing electrolytes, the energy store arrangement can also have a safety valve. Any gases produced during the controlled discharge, such as hydrogen or steam, can thus advantageously be dissipated outwardly. The creation of an overpressure in the energy store and the risk of an explosion can thus be avoided.

A further subject of the invention is a method for the controlled discharge of an energy store arrangement as described previously, said method comprising the steps of

i) triggering the delivery device, and

ii) delivering the redox shuttle additive from the storage container into the electrolyte of the energy store,

wherein the electrodes of the energy store come into contact with the redox shuttle additive present in the electrolyte and the energy store is partially or fully discharged in that the redox shuttle additive is oxidised at the cathode and is reduced at the anode, and

wherein the redox shuttle additive has a redox potential which is less than or equal to the potential of the partially or fully discharged cathode and greater than or equal to the potential of the partially or fully discharged anode.

With regard to preferred embodiments of the method according to the invention., reference is made to the above-described embodiments of the energy store arrangements, which can be applied equally for the method according to the invention.

Redox Shuttle Additive

In the present invention it has surprisingly been found that with use of a redox shuttle additive in a partially charged or fully charged energy store arrangement as described herein, this arrangement can be discharged in a controlled manner without use of an external electrical circuit.

The redox shuttle additives (redox shuttles) described hereinafter are usually substances that can be oxidised/reduced at least partially reversibly. The redox shuttle additive preferably can be reversibly oxidised/reduced. The term redox shuttle additive as used herein also includes combinations and mixtures of various substances, for example two, three, or more various redox shuttle additives.

For the discharge it is possible to use redox shuttle additives of the p-type, which in the starting state are present in the reduced form, and also additives of the which in the starting state are present in the oxidised form. The reaction schema (redox circuit) for redox shuttle additives of the p-type is as follows:

(1) oxidation of the reduced form at the cathode into the oxidised form, since the potential of the cathode is higher than the redox potential of the additive,

(2) diffusion/migration of the oxidised form from the cathode to the anode,

(3) reduction of the oxidised form at the anode into the reduced form, since the potential of the anode is lower than the redox potential of the additive,

(4) diffusion/migration of the reduced form from the anode to the cathode,

(5) step (1) again, and so on.

The reaction mechanism for additives of the n-type, which at the start are present in the oxidised form, starts accordingly with step (3).

Since, in the case of an energy store damaged by an accident or otherwise, no current flows via the outer electrical circuit, the electrodes of the energy store are discharged through the circuit of oxidation and reduction of the redox shuttle additive. The electrodes are thus then discharged. The discharge process continues until the cathode potential has reduced to values below the redox potential of the additive or until the anode potential has risen to values above the redox potential of the additive.

Whereas for applications of redox shuttle additives as reversible overcharge protection, extremely high reversibilities and stabilities are usually required over a long period of time and many cycles, or over a high charge throughput in order to protect the cells for as long as possible against overcharge, it is usually sufficient for the controlled discharge in accordance with the present invention that the additive can oxidise and reduce and is stable at least until the cell is fully discharged or until a discharge has continued until below a risk potential. Accordingly, in the present invention, compared to the application as protection against overcharge, redox shuttle additives which are not 100% reversible and/or which are not 100% stable can also be used.

The type, amount, and concentration of the redox shuttle additives are usually selected such that the energy store discharges over a period of time which enables quick and safe handling of the energy store discharged in a controlled manner, for example the removal thereof from an accident-damaged motor vehicle. With rising concentration or added amount, the duration of the discharge becomes shorter, provided the amount of added redox shuttle is still soluble in the electrolyte.

A controlled discharge preferably occurs over a period of time of from 2 minutes to 72 hours, preferably from 30 minutes to 24 hours, particularly preferably from 1 to 10 hours, wherein, depending on the application of the energy store, however, quicker or slower discharge times might also be necessary.

The discharge period is in particular dependent on the diffusion or migration speed (mobility) of the redox shuttle additive in the particular electrolyte and can therefore be influenced, depending on requirements, ideally by selection of the combination of redox shuttle additive and electrolyte. In particular, the discharge process can be adapted by selection of the aforementioned parameters, such that the discharge is performed as quickly as necessary, but slowly enough to ensure that the heat created during the discharge can be largely removed via radiation, convection, or contact with heat-conducting components and the cell does not heat up to temperatures at which thermal safety problems of the cell occur. With low additive concentrations, which result in a discharge rate over a number of hours, the heating of the cell usually does not pose a problem. If rapid discharge is necessary, for example a discharge within 10 minutes, within 5 minutes, or quicker, the heating of the energy store arrangement can be avoided for example by combination with an active or passive cooling system, as described above.

The redox shuttle additive can be present in the storage container both in solid or in liquid, preferably dissolved form. Alternatively, the redox shuttle additive can also be present in the storage container in the form of a dispersion. When the redox shuttle additive is present in solid form, for example in the absence of a solvent or as a dispersion, it is preferred if this is at least partially soluble in the electrolyte of the energy store. When the redox shuttle additive present in dissolved form, non-aqueous solutions are preferred. The presence of redox shuttle additives in the form of aqueous solutions, for example in the form of aqueous saline solutions, acids, and lyes, also leads to controlled discharge of the energy store due to the previously described mechanism, however it is disadvantageous here that, in the case of aqueous media, gas can form, generally as a side reaction, whereby combustible gases can form in particular at the anode. In order to avoid a risk caused by developing gases, which can lead to a rise in pressure inside the energy store and therefore to an explosion risk, it may be necessary to equip the energy store with a safety valve, for example an overpressure valve, and thus to additionally increase the level of safety. The addition of the redox shuttle additive in the form of aqueous solutions can be desired or necessary in spite of the possible formation of gases, for example for cost reasons or under consideration of environmental compatibility.

The addition of a redox shuttle additive in the form of non-aqueous solutions is preferred, since here the discharge current flows primarily via the oxidation and reduction of the redox pair of the redox shuttle additive and therefore no side reactions occur, The formation of potentially dangerous gaseous products can thus be avoided or completely suppressed.

The amount of redox shuttle additive present in the storage container, and, when the redox shuttle additive is present in dissolved form, the concentration of the redox shuttle additive are not especially restricted. Both the amount and concentration of the redox shuttle additive are typically dependent on the physical dimensions, the amount, and type of electrolyte and also on the charging voltage of the energy store.

The amount of the redox shuttle additive present in the storage container is between 0.1 and 1,000 g, preferably 1 to 100 g, wherein, depending on the type of redox shuttle additive and the dimensions of the energy store, smaller or larger amounts can also be used.

The concentration of the redox shuttle additive in the electrolyte, after addition into the electrolyte of the energy store, is preferably from 0.005 mol/L to 10 mol/L, preferably from 0.05 to 5 mol/L, particularly preferably from 0.1 to 2 mol/L, wherein the concentration, however, can also be lower or higher depending on the type of redox shuttle additive and the electrolyte of the energy store.

The type of redox shuttle additive is not particularly restricted, provided the substance can be oxidised at least partially reversibly and can be reduced at least partially reversibly.

In a preferred embodiment the redox shuttle additive is an organic compound, selected from the class of
aryl-quinone compounds, such as benzoquinone compounds (for example 2,6-di-tert-butyl-1,4-benzoquinone) or anthraquinone compounds,
alkoxy-aryl compounds, such as mono-alkoxy benzene compounds (for example anisol) or di-alkoxy benzene compounds (for example 2,5-di-tert-butyl-1,4-dimethoxybenzene, butoxy-1,4-dimethoxybenzene, 1,4-di-tert-butyl-2,5-bis(2,2,2-trifluoroethoxy)benzene, or 1,4-bis(2-methoxyethoxy)-2,5-di-tert-butyl benzene),
aryl-pseudo halide compounds, such as phenyl(iso)cyanates or phenyl(iso)thiocyanates (for example 5-chloro-2,4-dimethoxy phenyl isocyanate, 1,4-diisocyanato-2,3,5,6-tetramethyl benzene),
ester compounds, such as boric acid ester (for example dioxaborol compounds, such at 2-(pentafluorophenyl)tetrafluoro-1,3,2-benzodioxaborol) or phosphoric acid ester (such as tetraethyl-2,5-di-tert-butyl-1,4-phenylene diphosphate),
nitroxyl compounds, such as 2,2,6,6-tetramethyl piperidinyloxyl (TEMPO) and derivatives thereof (for example 4-cyano-2,2,6,6-tetramethyl piperidinyloxyl, 4-methoxy-2,2,6,6-tetramethyl piperidinyloxyl) or 2,2,5,5-tetramethyl-1-pyrrolidinyloxyl (PROXYL) and derivatives thereof (for example 3-cyano-2,2,5,5-tetramethyl-1-pyrrolidinyloxyl),
aryl-amino compounds, such as triphenylamine or tris(4-bromophenyl)amines,
nitrogen-containing and/or oxygen-containing and/or sulphur-containing aromatic or non-aromatic heterocyclic compounds, such as phenothiazines (for example 10-methyl phenothiazine, 3-chloro-10-ethyl phenothiazine).

In an alternative embodiment, the redox shuttle additive is a salt, preferably a salt of an alkali metal or alkaline earth metal, for example a lithium-based or other salt compound, preferably selected from the class of halides, such as LiI, LiBr, NaI, NaBr, KI, KBr, CaI₂, CaBr₂, MgI₂, or MgBr₂
pseudohalides, such as LiSCN or LiOCN,
dodecaborates of formula Li₂Br₂X₁₂₋ₓHₓ (with 0≦x≦12 and X═F, Cl, Br), such as Li₂B₁₂F₁₂ or Li₂B₁₂F₉H₃.

In an alternative embodiment, the redox shuttle additive contains a metal ion that can be reversibly oxidised/reduced or a compound having metal centres that can be reversibly oxidised/reduced, preferably selected from Fe²⁺/Fe³⁺, Co²⁺/Co³⁺, Ni²⁺/Ni³⁺, Cr²⁺/Cr³⁺, Sn²⁺/Sn⁴⁺, Mn²⁺/Mn⁷⁺ and V²⁺/V³⁺/V⁴⁺/V⁵⁺, particularly preferably selected from ferrocene and derivatives thereof, cobaltocene and derivatives thereof, hexacyanoferrate compounds, and permanganate compounds.

The selection of the redox shuttle is directed towards the used electrode materials or towards the potential ranges within which these can be charged and discharged. For example, the cathode material LiFePO₄ works between approximately 3.3 and 3.6 V vs. Li/Li⁺, LiMnPO₄ between approximately 3.8 and 4.2 V vs. Li/Li⁺, LiMnₓFe₁₋ₓPO₄ between approximately 3.3 and. 4.2 V vs. Li/Li⁺, the materials LiCoO₂, LiNi_{0.80}Co_{0.15}Al_{0.05}O₂ and LiNi_{0.33}1Mn_{0.33}Co_{0.33}O₂ between approximately 3.5 and 4.3 V vs. Li/Li⁺, 0.67ₓLi₂MnO₃.(1-x)LiNi_{y}Mn_{z}Co_{1-y-z}O₂ (for example Li_{1.2}Ni_{0.15}Mn_{0.55}Co_{0.1}O₂) between approximately 3.0 and 4.5 V vs. Li/Li⁺, LiMn₂O₄ (lithium-manganese spinel) between approximately 3.8 and 4.4 V vs. Li/Li⁺, and LiNi_{0.5}Mn_{1.5}O₄ (“high-voltage spinel”) between approximately 4.6 and approximately 4.9 V vs. Li/Li⁺, and the anode materials graphite between approximately 0 and 0.3 V vs. Li/Li⁺, amorphous carbon between approximately 0 and 1.3 V vs. Li/Li⁺, Li₄Ti₅O₁₂ (lithium-titanium spinel) between approximately 1.3 and 1.7 vs. Li/Li⁺, silicone between approximately 0 and 0.6 V vs. Li/Li⁺, and lithium metal by approximately 0 V vs. Li/Li⁺. Consequently, ferrocenes for example (with a redox potential of approximately 3.2 V vs. Li/Li⁺) can be used for the (practically) full discharge of all specified cathode materials, TEMPO (with a redox potential of approximately 3.5 V vs. Li/Li⁺) and 10-methylphenothiazine (with a redox potential of approximately 3.5 V vs. Li/Li⁺) can be used for the (practically) full discharge of all specified cathode materials apart from 0.67xLi₂MnO₃.(1-x)LiNi_{y}Mn₂Co_{1-y-z}O₂ and for the partial discharge of 0.67xLi₂MnO₃.(1-x)LiNi_{y}Mn_{z}Co_{1-y-z}O₂, 2,5-di-tert-butyl-1,4-dimethoxy benzene (with a redox potential of approximately 3.9 V vs. Li/Li⁺) and 2,5-di-tert-butoxy-1,4-dimethoxy benzene (with a redox potential of approximately 3.9 V vs. Li/Li⁺) can be used for the (practically) full discharge of LiMnPo₄, LiMn₂O₄ and LiNi_{0.5}Mn_{1.5}O₄ and. partial discharge of LiMnₓFe₁₋ₓPO₄, LiCoO₂, LiNi_{0.80}Co_{1.5}Al_{0.05}O₂, LiNi_{0.33}Mn_{0.33}Co_{0.33}O₂ and 0.67xLi₂MnO₃.(1-x)LiNd_{y}Mn_{z}Co_{1-y-x}O₂, and Li₂B₁₂F₉H₃ (with a redox potential of approximately 4.5 V vs. Li/L⁺) can be used for the (practically) full discharge of LiNi_{0.5} Mn_{1.5}O₄ and the discharge of 0.67xLi₂MnO₃.(1-x)LiNi_{y}Mn_{z}Co_{1-y-z}O₂. Since the redox potentials of the specified redox shuttles are higher than those of the specified anode materials, all specified anode materials can be used in the above-specified redox shuttle/cathode combinations.

In an alternative embodiment the redox shuttle additive is present in the storage container in a solvent or electrolyte, wherein the electrolyte can also be the solvent for the redox shuttle additive. A non-aqueous solvent is preferred for the solvent, wherein, depending on the type of the redox shuttle additive or the electrolyte of the energy store, water-containing solvents can also be suitable or necessary. Preferred non-aqueous solvents are selected from organic carbonates (such as ethylene carbonate, propylene carbonate, dimethyl carbonate, ethylmethyl carbonate, diethyl carbonate, fluoroethylene carbonate, etc.), carboxylic acid esters (such as ethyl acetate, gamma butyrolactone, gamma valerolactone, delta valerolactone, etc.), sulfones (such as ethylmethyl sulfone, sulfolan, etc.), sulfoxides (such as dimethyl suifoxide, etc.), ethers (such as dimethoxyethane, diglymes, triglymes, tetraglymes, tetrahydxofuran, 2-methyltetrahydrofuran, etc.), nitriles (acetonitrile, adiponitrile, gleutaronitrile, 2-methylglutaronitrile, etc.) and amides (such as dimethyl formamide, etc.) and mixtures thereof.

The electrolyte is more preferably an anhydrous electrolyte, particularly preferably selected from solutions of LiPF₆, lithium bis(trifluoromethylsulfonyl)imide (LiTESI), lithium bis(fluorosulfonyl)imide (LiFSI), lithium bis(oxalato)borate (LiBOB), lithium difluoro(oxalate)borate (LiDFOB), lithium tris(pentafluoroethyl)trifluorophosphate (LiFAP), etc, in the above-mentioned solvents or solvent mixtures. Typical examples for such electrolytes are 1 mol/L LiPF₆ in ethylene carbonate:dimethyl carbonate (1:1), 1 mol/L LiPF₆ in ethylene carbonate:ethylmethyl carbonate (3:7) and 1 mol/L LiPF₆ in ethylene carbonate:dimethyl carbonate:ethyl acetate (1:1:1).

Effect

Due to the use of redox shuttle additives in an energy store arrangement and also a method as described above, it is possible to fully discharge partially or fully charged batteries within a period of time from a few minutes to a few days without the need, for this purpose, of a discharge via an external electrical circuit. In particular, it has surprisingly been found that substances which have a redox potential that as too low for use as protection against overcharge are outstandingly suitable for the discharge of energy store systems in a controlled manner.

It is thus possible to discharge energy stores in a controlled manner, in particular for the case in which the energy store and/or an associated energy control circuit connected thereto has been damaged due to a defect or accident. The energy store can thus be safely handled, for example can be recovered from a vehicle involved in an accident, without posing a risk to people.

The invention will be further described by the following examples, but without hereby limiting the invention.

### EXAMPLES

### Comparative Example 1

Behaviour of a Battery Cell without Addition of a Redox Shuttle Additive

A prismatic Li-ion cell having a nominal capacity of 20 Ah with graphite anode and layered oxide cathode (LiNi_{0.33}Mn_{0.33}Co_{0.33}O₂) was galvanostatically charged with a current of 20 A up to an end charging voltage of 4.1 V. Once the charging current was switched off, the cell voltage relaxed within approximately 0.5 h to a rest voltage of 4.085 V.

The cell was then stored at room temperature with open terminals. The cell voltage reduced within 3 months by less than 0.034 V.

### Example 2

Behaviour of a Battery Cell with Addition of Demineralised Water

A prismatic Li-ion cell having a nominal capacity of 20 Ah with graphite anode and layered oxide cathode (LiNi_{0.33}Mn_{0.33}Co_{0.33}O₂) was galvanostatically charged with a current of 20 A up to an end charging voltage of 4.1 V. Once the charging current was switched off, the cell voltage relaxed within approximately 0.5 h to a rest voltage of 4.085 V.

A hole was then drilled in the cell and closed again by a septum.

20 mL of demineralised water was then injected via the septum within a period of 1 h. After this addition, the voltage of the cell and the temperature of the cell were continuously recorded in addition, the amount of developing gas was recorded via a gas-measuring apparatus consisting of a glass flask and cylinder and connected to the gas chamber of the cell via a capillary tube and a needle penetrating the septum.

The cell discharged fully within 56 h from addition of the demineralised water (to <2 V voltage). The cell voltage after 73 h was 0.92 V. The temperature of the cell rose during the discharge by no more than 3° C. (which is within the natural temperature fluctuations in the test room). The cell experienced significant gas formation during the discharge, with 525 mL of gas formed.

### Example 3

Behaviour of a Battery Cell with Addition of Mains Water

The behaviour was examined as in Example 2, with the difference that 20 mL of mains water were added instead of 20 mL of demineralised water.

The cell discharged fully within 35 h from addition of the mains water (to <2 V voltage). The cell voltage after 43 h was 0.98 V. The temperature of the cell rose during the discharge by no more than 3° C. (which is within the natural temperature fluctuations in the test room). The cell experienced significant gas formation during the discharge, with 53 min of gas formed.

### Example 4

Behaviour of the Battery Cell with Addition of Aqueous CaCl₂ Solution

The behaviour was examined as in Example 2, with the difference that 20 ml of 1.0 mol/L aqueous CaCl₂ solution were added instead of 20 mL of demineralised water.

The cell discharged fully within 30 h from addition of the CaCl₂ solution (to <2 V cell voltage). The cell voltage after 45 h was 0.65 V. The temperature of the cell rose during the discharge by no more than 3° C. (which is within the natural temperature fluctuations in the test room). The cell experienced significant gas formation during the discharge, and 189 mL of gas were measured, until additional corrosion (pitting) of the Al-cell housing occurred and the remaining gas could escape via this leakage point.

### Example 5

Behaviour of the Battery Cell with addition of a Ferrocene-Electrolyte Mixture

The behaviour was examined as in Example 2, with the difference that 20 mL of an anhydrous ferrocene-electrolyte mixture were added instead of 20 mL of demineralised water. The mixture was produced by dissolving 0.1 mol/F of ferrocene [Bis(η5-cyclopentadienyl)iron, Fe (C₅H₅)₂] in 1 mol/L LiPF₆ in a solvent mixture of 50% by weight ethylene carbonate (1,3-dioxalan-2-one, C₃H₄O₃) and 50% by weight of dimethyl carbonate (carbonic acid dimethyl ester, C₃H₆O₃) with exclusion of air and moisture.

The cell discharged fully within 61 h from addition of the ferrocene-containing electrolyte solution (to <2 V cell voltage). The cell voltage after 100 h was 0.18 V. The temperature of the cell rose during the discharge by no more than 3° C. (which is within the natural temperature fluctuations in the test room). No gas formation was determined during the discharge. There was no corrosion of the cell housing.

### Example 6

Behaviour of the Battery Cell with Addition of a Non-Aqueous Ferrocene Solution

The behaviour was examined as in Example 2, with the difference that, instead of 20 mL of demineralised water, a total of 20 mL of a saturated solution of ferrocene [Bis(η5-cyclopentadienyl)iron, Fe (C₅H₅)₂] in a solvent mixture of 50% by weight ethylene carbonate (1,3-dioxalan-2-one, C₃H₄O₃) and 50% by weight of dimethyl carbonate (carbonic acid dimethyl ester, C₃H₆O₃) were added.

The cell discharged fully within 42 h from addition of the ferrocene solution (to <2 V cell voltage). The cell voltage after 100 h was 0.06 V. The temperature of the cell rose during the discharge by no more than 3° C. (which is within the natural temperature fluctuations in the test room). No gas formation was determined during the discharge. There was no corrosion of the cell housing.

### Example 7

Behaviour of the Battery Cell with Addition of a Non-Aqueous TEMPO Solution

The behaviour was examined as in Example 2, with the difference that, instead of 20 ml of demineralised water, a total of 20 mL of a 1 mol/L solution of TEMPO (2,2,6,6-tetramethylpiperidinyloxyl) in a solvent mixture of 50% by weight ethylene carbonate (1,3-dioxalan-2-one, C₃H₄O₃) and 50% by weight of dimethyl carbonate (carbonic acid dimethyl ester, C₃H₆O₃) were added.

The cell discharged fully within 39 h from addition of the TEMPO solution (to <2 V cell voltage). The cell voltage after 48 h was 0.02 V. The temperature of the cell rose during the discharge by no more than 30° C. (which is within the natural temperature fluctuations in the test room). No gas formation was determined during the discharge. There was no corrosion of the cell housing.

### Example 8

Behaviour of the Battery Cell with Addition of a Non-Aqueous DTB-DMB Solution

The behaviour was examined as in Example 2, with the difference that, instead of 20 mL of demineralised water, a total of 20 ml of a 0.05 mol/L solution of DTB/DMB (2,5-di-tert-butyl-1,4-dimethoxybenzene) in a solvent mixture of 50% by weight ethylene carbonate (1,3-ioxalan-2-one, C₃H₄O₃) and 50% by weight of dimethyl carbonate (carbonic acid dimethyl ester, C₃H₆O₃) were added.

The cell discharged only partially within 400 h from addition of the DTB-DMB solution to a voltage of 3.7 V. No gas formation was determined during the discharge. There was no corrosion of the cell housing.

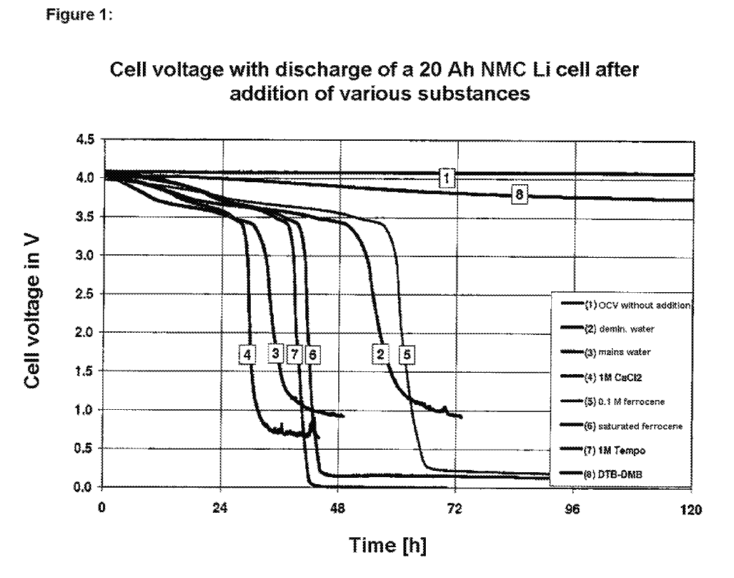

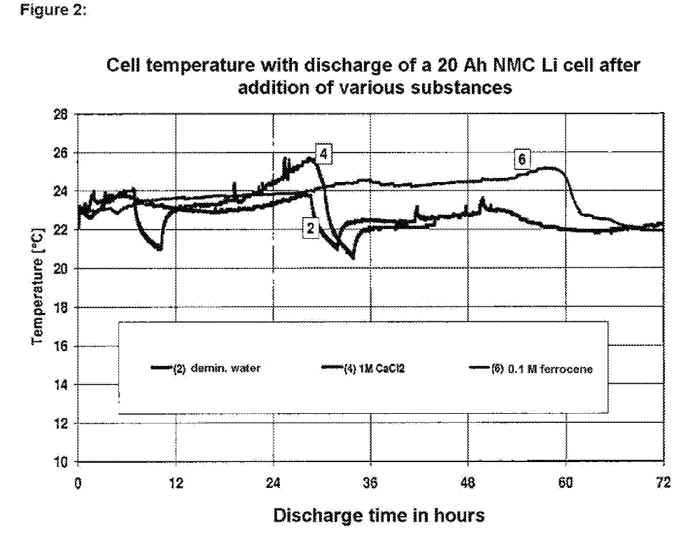

The profiles of the cell voltage and of the cell temperature after addition of the substances specified in the above-described examples into the electrolyte of the cell are shown in FIGS. 1 and 2. Here, it can be seen that the cell discharged in a controlled manner by addition of the substances into the electrolyte of the cell, without a significant rise in temperature.

1. An energy store arrangement, containing
(1) an energy store having at least one negative electrode (“anode”), at least one positive electrode (“cathode”), electrolyte, and electric poles, via which the energy store at the least can be discharged,
(2) a storage container, containing a redox shuttle additive, and
(3) a triggerable delivery device by means of which, when triggered, the redox shuttle additive is delivered into the electrolyte of the energy store in such a way that the cathode and the anode of the energy store are in contact with the redox shuttle additive provided in the electrolyte and the energy store is discharged partially or fully in that the redox shuttle additive is oxidised at the cathode and reduced at the anode,
wherein the redox shuttle additive has a redox potential which is less than or equal to the potential of the partially or fully discharged cathode and is greater than or equal to the potential of the partially or fully discharged anode.

2. The energy store arrangement according to claim 1, wherein the energy store is a battery, preferably a rechargeable battery, and more preferably a rechargeable lithium-ion secondary cell.

3. The energy store arrangement according to claim 1, wherein the redox shuttle additive can be at least partially reversibly oxidised and partially reversibly reduced.

4. The energy store arrangement according to claim 1, wherein the amount of the redox shuttle additive is selected in such a way that the concentration of the redox shuttle additive in the electrolyte is from 0.005 mol/L to 10 mol/1, preferably from 0.05 to 5 mol/L, particularly preferably from 0.1 to 2 mol/L.

5. The energy store arrangement according to claim 1, wherein the redox shuttle additive is an organic compound, selected from aryl quinones, alkoxyaryl hydrocarbons, aryl pseudohalides, esters, nitroxylene, aryl amines, and phenothiazines.

6. The energy store arrangement according to claim 1, wherein the redox shuttle additive is a salt, preferably a salt of an alkali metal or alkaline earth metal, particularly preferably selected from halides, pseudohalides, and dodecaborates.

7. The energy store arrangement according to claim 1, wherein the redox shuttle additive is a metal ion that can be reversibly oxidised/reduced or a compound having metal centres that can be reversibly oxidised/reduced, preferably selected from Fe²⁺/Fe³⁺, Co²⁺/Co³⁺, Ni²⁺/Ni³⁺, Cr²⁺/Cr³⁺, Sn²⁺/Sn⁴⁺, Mn²⁺/Mn⁷⁺ and V²⁺/V³⁺/V⁴⁺/V⁵⁺.

8. The energy store arrangement according to claim 1, wherein the redox shuttle additive is present in the storage container in a solvent or electrolyte.

9. The energy store arrangement according to claim 8, wherein the solvent is a non-aqueous or water-containing solvent.

10. The energy store arrangement according to claim 1, wherein the electrolyte is an anhydrous electrolyte.

11. The energy store arrangement according to claim 1, also containing a cooling device.

12. The energy store arrangement according to claim 1, also containing an overpressure valve.

13. The energy store arrangement according to claim 1, wherein the triggerable delivery device is selected from a predetermined breaking point, micro explosive charge, a mechanically, thermally, chemically and/or electrically controlled release mechanism, preferably a valve and/or sensor.

14. A method for the controlled discharge of an energy store arrangement as defined in claim 1, said method comprising the steps of
i) triggering the delivery device, and
ii) delivering the redox shuttle additive from the storage container into the electrolyte of the energy store,
wherein the electrodes of the energy store come into contact with the redox shuttle additive present in the electrolyte and the energy store is partially or fully discharged in that the redox shuttle additive is oxidised at the cathode and is reduced at the anode, and
wherein the redox shuttle additive has a redox potential which is less than or equal to the potential of the partially or fully discharged cathode and greater than or equal to the potential of the partially or fully discharged anode.

15. The method according to claim 14, wherein the energy store is discharged over a period of from 2 minutes to 72 hours, preferably from 30 minutes to 24 hours, particularly preferably from 1 to 10 hours.

16. Use of a redox shuttle additive for the controlled discharge of an at least partially charged energy store.

17. The use of a redox shuttle additive according to claim 16, wherein the at least partially charged energy store is a battery, preferably a rechargeable battery, more preferably a lithium-ion secondary cell.

18. The use of a redox shuttle additive according to claim 16, wherein the redox shuttle additive is an organic compound, selected from aryl quinones, anthraquinones, alkoxyaryl hydrocarbons, aryl pseudohalides, esters, nitroxylene, aryl amines, and phenothiazines.

19. The use of a redox shuttle additive according to claim 16, wherein the redox shuttle additive is a salt, preferably a salt of an alkali metal or alkaline earth metal, particularly preferably selected from halides, pseudohalides, and dodecaborates.

20. The use of a redox shuttle additive according to claim 16, wherein the redox shuttle additive is a metal ion that can be reversibly oxidised/reduced or a compound having metal centres that can be reversibly oxidised/reduced, preferably selected from Fe²⁺/Fe³⁺, Co²⁺/Co³⁺, Ni²⁺/Ni³⁺, Cr²⁺/Cr³⁺, Sn²⁺/Sn⁴⁺, Mn²⁺/Mn⁷⁺ and V²⁺/V³⁺/V⁴⁺/V⁵⁺.

21. The use of a redox shuttle additive according to claim 16, wherein the at least partially charged energy store is part of a stationary, portable, or mobile application, preferably part of a hybrid vehicle, plug-in hybrid vehicle, or electric vehicle.
